(19) United States
(12) Patent Application Publication
(10) Pub. No.: US 2003/0233908 A1
(43) Pub. Date: Dec. 25, 2003

(54) Gearbox for an electrical scooter

(76) Inventor: Charles M. Cheng, Bridgewater, NJ (US)

Correspondence Address: DELLETT AND WALTERS, 310 S.W. FOURTH AVENUE, SUITE 1101, PORTLAND, OR, 97204, US

(21) Appl. No.: 10/177,921

(22) Filed: Jun. 19, 2002

(51) Int. Cl. F16H 33/00; F16H 35/00; F16H 37/00

(52) U.S. Cl. 74/640

(57) ABSTRACT

A gearbox for an electrical scooter, an electrical wheelchair or the like has a housing, an input axle, an output axle and a lubricant bushing. The input axle is rotatably mounted in the housing and is adapted to be connected to a motor shaft. The output axle is rotatably mounted in the housing and is connected to the input axle with a transmitting device. The lubricant bushing is mounted in the housing and is mounted around the second end of the input axle so that the input axle can freely rotate relative to the housing. With the lubricant bushing, the space in the housing for mounting the input axle is reduced.

### BACKGROUND OF THE INVENTION

1. Field of the Invention

The present invention relates to a gearbox, and more particularly to a gearbox for an electrical scooter or an electrical wheelchair.

2. Description of Related Art

A gearbox is commonly arranged between a motor and a terminal device to reduce rotating speed applied to the terminal device. The conventional gearbox substantially comprises a housing, an input axle, an output axle and a transmitting device. The input axle is rotatably mounted in the gearbox and is connected to the motor shaft. The output axle is connected to the input axle with the transmitting device and is connected to the terminal device. Accordingly, the rotating speed of the output axle will be reduced to a lower level with use of the transmitting device.

With reference to FIG. 3, to make the input axle (42) freely rotate relative to the housing (40), a bearing (44) is mounted in the housing (40) and is mounted around one end of the input axle (42). However, a conventional bearing (44) substantially comprises an outer collar, a inner race and multiple steel balls mounted between the collar and race. A large space is needed for mounting the bearing (44) in the housing (40), otherwise the end of the input axle (42) for mounting the bearing (44) must be reduced. Consequently, the structural strength of the input axle is lowered, when the end of the input axle is reduced.

To overcome the shortcomings, the present invention tends to provide a gearbox to mitigate or obviate the aforementioned problems.

### SUMMARY OF THE INVENTION

The main objective of the invention is to provide a gearbox for an electrical scooter, an electrical wheelchair or the like and that can reduce the space for mounting the input axle. The gearbox has a housing, an input axle, an output axle and a lubricant bushing. The input axle is rotatably mounted in the housing and is adapted to be connected to a motor shaft. The output axle is rotatably mounted in the housing and is connected to the input axle with a transmitting device. The lubricant bushing is mounted in the housing and is further mounted around the second end of the input axle so that the input axle can freely rotate relative to the housing. With the lubricant bushing, the space in the housing for mounting the input axle is reduced.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a gearbox in accordance with the present invention;

FIG. 2 is a top plan view in partial cross section of the housing and the input axle of the gearbox in FIG. 1; and

FIG. 3 is a top plan view in partial cross section of a housing and an input axle of a conventional gearbox in accordance with the prior art.

### DETAILED DESCRIPTION OF PREFERRED EMBODIMENT

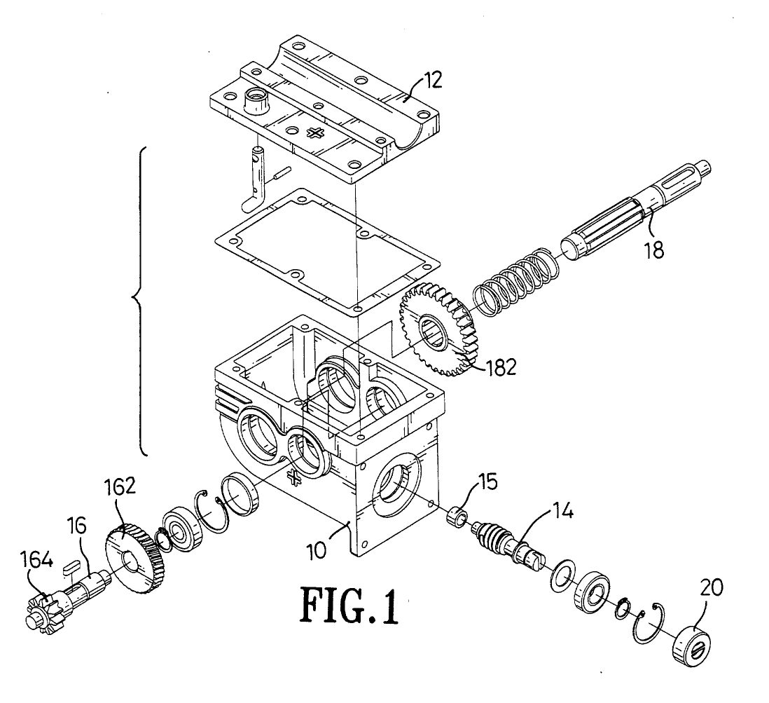

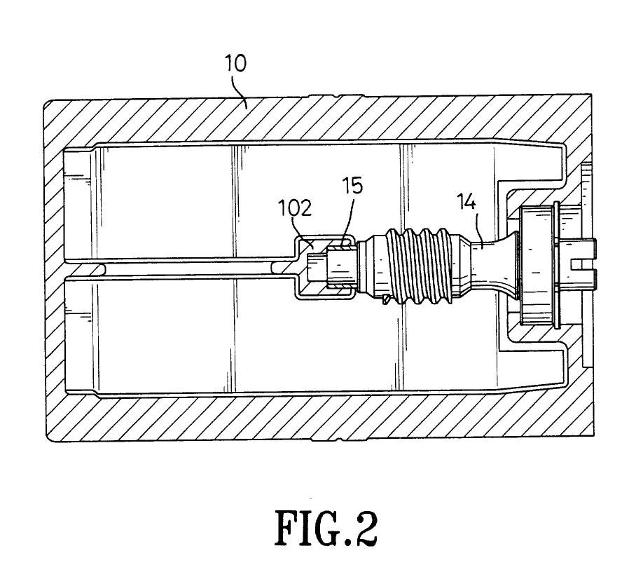

With reference to FIGS. 1 and 2, a gearbox for an electrical scooter, an electrical wheelchair or the like in accordance with the present invention comprises a housing (10), an input axle (14), an output axle (18) and a transmitting device. The housing (10) has a top opening defined in the top of the housing (10). A cover (12) is mounted on the top of the housing (10) to close the top opening in the housing (10). The input axle (14) is rotatably mounted in the housing (10). The input axle (14) has a first end extending out from the housing (10) and adapted to be connected to a motor shaft (not shown) with a connector (20). An outer thread (not numbered) is formed on the outer periphery of the input axle (14) so as to serve the input axle (14) as a worm. A lubricant bushing (15) containing lubricant oil is mounted in a base (102) formed in the housing (10) and is mounted around a second end of the input axle (14). With the arrangement of the lubricant bushing (15), the input axle (14) can freely rotate relative to the housing (10).

The output axle (18) is rotatably mounted in the housing (10) and is connected to the input axle (14) with the transmitting device. The output axle (18) has one end extending out from the housing (10) and is connected to a terminal device. In practice, the transmitting device comprises a transmitting axle (16), a worm gear (162) and a gear (182). The transmitting axle (16) is rotatably mounted in the housing (10) and has a pinion (164) mounted on the transmitting axle (16). The worm gear (162) is mounted on the transmitting axle (16) to engage with the outer thread on the input axle (14). The gear (182) is mounted on the output axle (18) and engages with the pinion (164) on the transmitting axle (16).

Accordingly, when the motor is switched on, the output axle (14) will rotate with the motor shaft and the output axle (18) will be actuated to rotate with the transmission of the transmitting device. With the arrangement of the outer thread on the input axle (14) and the worm gear (162), the speed of the output axle (18) is reduced to a lower level. Consequently, the terminal device will be actuated to operate at a desired speed.

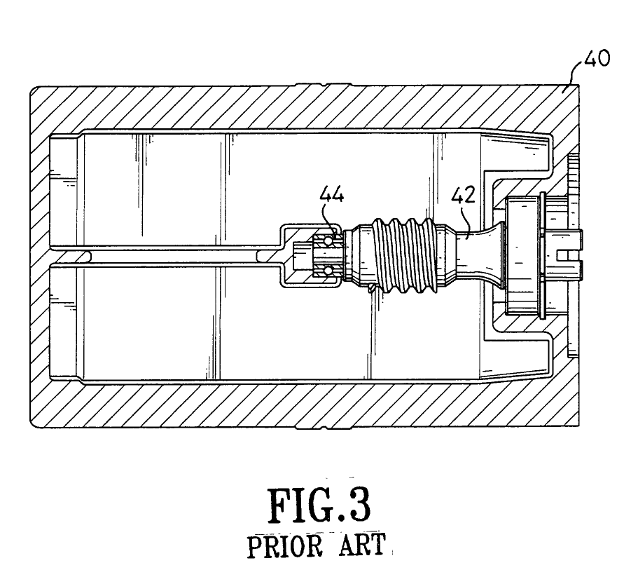

Because the structure of the lubricant bushing (15) is simpler than that of a conventional bearing (44) as shown in FIG. 3, the space in the base (102) of the housing (10) for mounting the lubricant bushing (15) is reduced. Accordingly, the space for mounting the input axle (14) is also reduced. In addition, to reduce the second end of the input axle (14) is not needed, such that the structural strength of the input axle (14) is enhanced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gearbox for an electrical scooter comprising:
a housing;
an input axle rotatably mounted in the housing and adapted to be connected to a motor shaft, and having an outer thread formed on an outer periphery of the input axle to form the input axle to a worm, a first end extending out from the housing and a second end; and
an output axle rotatably mounted in the housing and connected to the input axle with a transmitting device,
wherein a lubricant bushing containing lubricant oil is mounted in the housing and is mounted around the second end of the input axle so that the input axle can freely rotate relative to the housing.

2. The gearbox as claimed in claim 1, wherein the transmitting device comprises:
a transmitting axle rotatably mounted in the housing and having a pinion mounted on the transmitting axle;
a worm gear mounted on the transmitting axle to engage with the outer thread on the input axle; and
a gear mounted on the output axle and engaging with the pinion on the transmitting axle.

3. The gearbox as claimed in claim 1, wherein the housing has a top opening defined in a top of the housing; and
a cover is mounted on the top of the housing to close the top opening in the housing.
